(19) United States
(12) Patent Application Publication
(10) Pub. No.: US 2026/0203778 A1
(43) Pub. Date: Jul. 16, 2026

(54) METHODS, SYSTEMS, ARTICLES OF MANUFACTURE AND APPARATUS TO DETERMINE PRODUCT SIMILARITY SCORES

(71) Applicant: Nielsen Consumer LLC, Chicago, IL (US)

(72) Inventors: Aritra Kanjilal, Kolkata (IN); David Anthony Duncan, Milford, OH (US); Matt Senger, Chicago, IL (US)

(21) Appl. No.: 19/420,012

(22) Filed: Dec. 15, 2025

Related U.S. Application Data
(63) Continuation of application No. 18/480,784, filed on Oct. 4, 2023, now abandoned.
Application No. 18/480,784 is a continuation of application No. 17/521,598, filed on Nov. 8, 2021, now abandoned.
(60) Provisional application No. 63/167,487, filed on Mar. 29, 2021.

(51) Int. Cl. G06Q 30/0201; G06Q 30/0202

(52) U.S. Cl. CPC G06Q 30/0201; G06Q 30/0202

(57) ABSTRACT

Methods, systems, articles of manufacture and apparatus to determine product similarity scores are disclosed. An example apparatus includes calculation set generating circuitry to identify a set of candidate comparison items based on primary characteristics corresponding to the a focus item, and generate a calculation set of items from the set of candidate comparison items based on secondary characteristics corresponding to market performance, and weight calculating circuitry to calculate primary characteristic scores corresponding to the focus item, the primary characteristic scores based on a uniqueness between the primary characteristics corresponding to the focus item and primary characteristics corresponding to the calculation set of items.

### RELATED APPLICATION

This patent arises from a continuation of U.S. patent application Ser. No. 18/480,784, which was filed on Oct. 4, 2023. U.S. patent application Ser. No. 18/480,784 is a continuation of U.S. patent application Ser. No. 17/521,598, which was filed on Nov. 8, 2021. U.S. patent application Ser. No. 17/521,598 claims the benefit of U.S. Provisional Patent Application No. 63/167,487, which was filed on Mar. 29, 2021. U.S. patent application Ser. No. 18/480,784, U.S. application Ser. No. 17/521,598, and U.S. Provisional Patent Application No. 63/167,487 are hereby incorporated herein by reference in their entireties. Priority to U.S. patent application Ser. No. 18/480,784, U.S. application Ser. No. 17/521,598, and U.S. Provisional Patent Application No. 63/167,487 is hereby claimed.

### FIELD OF THE DISCLOSURE

This disclosure relates generally to the technical field of market research, and, more particularly, to methods, systems, articles of manufacture and apparatus to determine product similarity scores.

### BACKGROUND

In recent years, increasing numbers of products have emerged in marketplaces. As additional competitors (e.g., manufacturers) enter these marketplaces, a corresponding number of associated products result, in which those products can include any number of different characteristics.

### BRIEF DESCRIPTION OF THE DRAWINGS

FIG. 1 is a schematic illustration of an example similarity score system constructed in accordance with the teachings of this disclosure to determine similarity scores.

FIGS. 2-6 are example tables generated by the example similarity score system of FIG. 1.

FIGS. 7-9 are flowcharts representative of machine readable instructions which may be executed to implement the example similarity score system of FIG. 1.

FIG. 10 is a block diagram of an example processing platform including processor circuitry structured to execute the example machine readable instructions of FIGS. 7-9 to implement the example similarity score system of FIG. 1.

FIG. 11 is a block diagram of an example implementation of the processor circuitry of FIG. 10.

FIG. 12 is a block diagram of another example implementation of the processor circuitry of FIG. 10.

FIG. 13 is a block diagram of an example software distribution platform (e.g., one or more servers) to distribute software (e.g., software corresponding to the example machine readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using any type of training algorithm. In examples disclosed herein, training is performed until one or more triggers, thresholds and/or iterations. In examples disclosed herein, training is performed on local device(s) and/or on network-accessible device(s). Training is performed using hyperparameters that control how the learning is performed (e.g., a learning rate, a number of layers to be used in the machine learning model, etc.). In some examples re-training may be performed. Such re-training may be performed in response to increasing differences between actual results and expected results, for instance.

Training is performed using training data. Because supervised training is used, the training data is labeled. Labeling is applied to the training data. In some examples, the training data is pre-processed and in other examples, the training data is sub-divided.

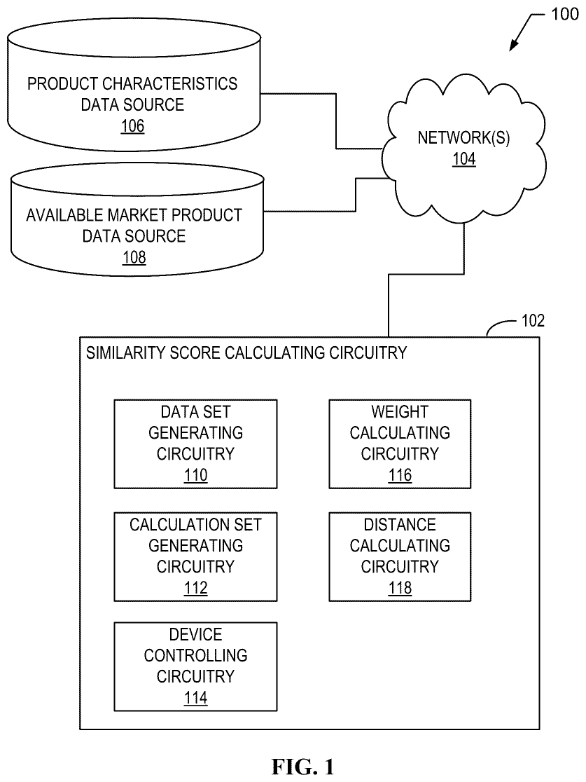

Once training is complete, the model is deployed for use as an executable construct that processes an input and provides an output based on the network of nodes and connections defined in the model. The model is stored at any local and/or network accessible device. The model may then be executed (e.g., by the system 100 of FIG. 1).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Market analysts, product specialists and/or personnel chartered with the responsibility of market research are confronted with a number of products and corresponding manufacturers beyond which can be reasonably evaluated in time for certain marketing campaigns. For instance, if a manufacturer must quickly insert a product into a market of interest based on observing competitive activity, then that manufacturer must also appreciate the competitor product, and must also consider other competitive products that could be deemed similar. Despite the fact that the technical field of market research includes technological tools to process information corresponding to products, such technological tools (e.g., uniquely programmed computing devices, circuits, etc.) may still require human input. For instance, upon learning of a new product that is to be introduced into a particular market (e.g., a geographical/regional market of interest), the market analyst must apply his/her discretion when identifying other already-existing product in that market that might be considered similar. However, such efforts to identify a degree of similarity between the new product and existing products is fraught with error in view of the discretionary disparity between one market analyst and another market analyst.

Examples disclosed herein analyze a set of existing market products in connection with a candidate product to be introduced into a market of interest. Examples disclosed herein calculate metrics corresponding to the candidate product using technological tools in a manner that causes those technological tools to operate with less error and avoid human discretion. While examples disclosed herein improve the technical field of market research and the operation of technical tools therein, at least some benefits of examples disclosed herein allow market analysts to develop marketing strategies for the candidate product and improve sales metrics. In some examples, identification of market-available items that are most similar to a focus item of interest (e.g., a new product to be introduced into a particular market, such as a specific geographical market) facilitates an ability to allocate marketing efforts to particular geographies, to particular product categories, and/or to particular retail locations in which the focus item of interest might be sold.

FIG. 1 is an example similarity score system 100 constructed in accordance with the teachings of this disclosure. In the illustrated example of FIG. 1, the similarity score system 100 includes an example similarity score calculating circuitry 102 communicatively connected to one or more networks 104. The example networks 104 are communicatively connected to an example product characteristics data source 106 (e.g., containing information corresponding to any number of product characteristics) and an example available market product data source 108 (e.g., containing information corresponding to any number of available products (e.g., including UPC information, SKU information, etc.)). However, in some examples the product characteristics data source 106 and/or the available market product data source 108 are part of (e.g., structurally) the example similarity score calculating circuitry 102 and/or otherwise communicatively connected via one or more busses.

The example similarity score calculating circuitry 102 includes example data set generating circuitry 110, example calculation generating circuitry 112, example device controlling circuitry 114, and example weight calculating circuitry 116. In operation, the example data set generating circuitry selects a focus item of interest. As used herein, a “focus item” is a product of interest that is to be scored in a manner that identifies, calculates and/or otherwise determines similarity score metrics in view of existing products in the market of interest. In some examples, a market analyst identifies the focus item provided by a manufacturer that is interested in selling a new product, but is unsure of how to market that new product. Any number of new products may be stored in a data store or memory for analysis. In some examples, the data set generating circuitry retrieves, receives and/or otherwise obtains a focus item of interest from a ranked list (e.g., stored in a memory, a database, etc.) of any number of focus items of interest. In some examples, the list of candidate focus items of interest is categorized based on product type, category, channel, etc., and may also be ranked. As described above, the focus item of interest may be a candidate product that is not yet introduced into the market (e.g., the market associated with the initial data set) such that market analysts desire to better appreciate which market-existing products might be most relevant. In other examples, the focus item of interest may be an existing product that is causing a particular market disruption. For instance, the existing product may exhibit particularly strong sales and the market analyst may desire to know which one or more other existing products are most similar. In some examples, knowledge of which products are most similar to a focus item enables particular marketing strategies to be performed in a manner that does not merely rely upon discretionary choices of the analyst(s).

The example calculation set generating circuitry 112 generates an initial set of primary characteristics that correspond to and/or are otherwise relevant to the focus item of interest. In some examples, the calculation set generating circuitry 112 selects primary characteristics of interest to be studied and/or otherwise analyzed, in which the selected primary characteristics are part of a same or similar product channel. As used herein, a product channel represents a combination of common primary characteristics for products. Example product channels include, but are not limited to beer, cider, soft drinks, fruit drinks, sports drinks, chips, snacks, breakfast cereals, etc. Additionally, items within the product channel of interest may include any number of primary characteristics of interest, such as flavor, size, pack size, claim(s), packaging, product type or form (e.g., powder vs. gel), seasonality (e.g., Easter, Halloween, etc.), etc. Example flavor primary characteristics include orange, caramel, apple, ginger, honey, lime, etc. Example size primary characteristics include any per-item volume, such as a 6-ounce container, a 12-ounce container, etc. Example pack size primary characteristics include two-pack, four-pack, six pack, etc. Example claims include low-sugar claims, low-sodium claims, etc.

The example calculation set generating circuitry 112 extracts any number of market-available items (e.g., products) from a data source that match the selected primary characteristics of interest. In some examples, market-available items are selected from the example product characteristics data source 106 and/or the example available market product data source 108. However, creating a set of candidate items that have one or more matching primary characteristics may result in a high volume or otherwise unmanageable list of candidate products to process and/or otherwise evaluate. Even with the aid of computational resources, the number of market available items corresponding to a candidate primary characteristic such as “soft drink” becomes voluminous and causes computational burdens during an analysis. As such, the example calculation set generating circuitry 112 generates a calculation set of items that also satisfy one or more secondary characteristics of interest such as, for example, products within a 1% ACV distribution threshold. In some examples, the secondary characteristics represent market parameters associated with items that have the matching primary characteristics. Example secondary characteristics, when applied, identify and/or otherwise remove one or more items (e.g., products) that do not have sufficient and/or threshold amounts of market exposure. To illustrate, if an item has primary characteristics of grape flavor, 16-ounce, and a low sugar claim, then an example secondary characteristic includes a sales velocity of 200 units per day. However, any other type of market parameter may be used for candidate secondary characteristics, such as a threshold amount of increased sales per unit of time, an all commodities volume (ACV) (e.g., distribution) metric, etc.

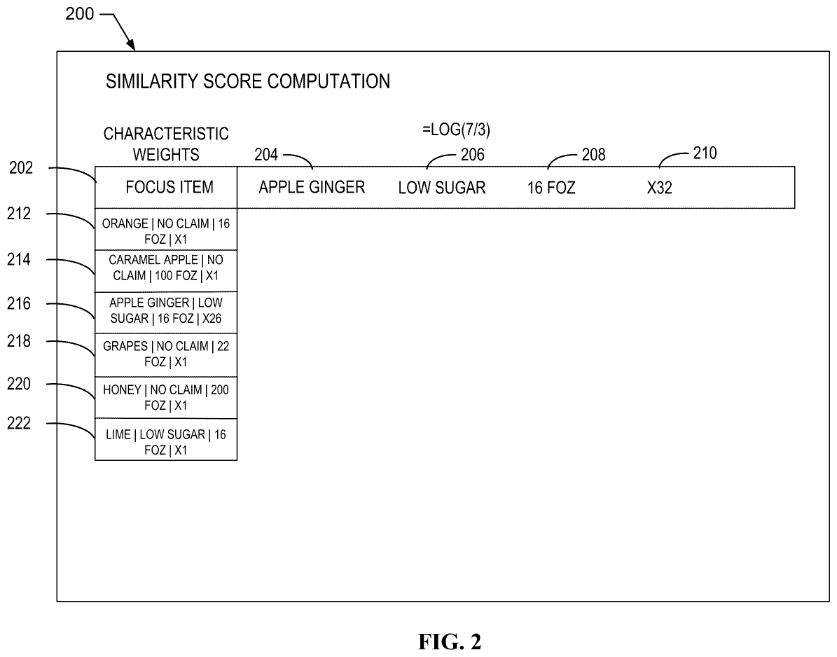

In the illustrated example of FIG. 2, the similarity score calculating circuitry 102 generates a table 200 having a focus item of interest 202. In particular, the focus item of interest 202 includes several example primary characteristics, such as primary characteristics corresponding to a flavor (Apple Ginger 204), a claim (Low Sugar 206), a size (16 fluid ounces 208), and a pack size (×32 210). As described above, the example calculation set generating circuitry 112 extracts market-available items that include primary characteristics that match some or all of the primary characteristics corresponding to the example focus item 202. Stated differently, for any given focus item of interest a similarity score is calculated for all other items within a particular product category that has satisfied (e.g., surpassed, crossed, etc.) a threshold ACV distribution metric (e.g., 1%). Worth noting is that some products may have very little in common with the focus item of interest other than the threshold ACV metric, yet similarity scores are still calculated. Additionally, the example calculation set generating circuitry 112 reduces the calculation set by applying one or more secondary characteristics to the list of items having one or more matching primary characteristics. That is, only those items that also include matching secondary characteristics are retained as a calculation set 203 to be analyzed against the example focus item 202. In the illustrated example of FIG. 2, the calculation set 203 items are retained because those items meet one or more secondary characteristic threshold values, such as a threshold volume of sales, an ACV metric, etc. In other words, similarity comparisons are limited to only those market available items that are relevant in the market of interest due to their market success (e.g., a threshold market volume, a threshold market distribution, a threshold market velocity per unit of time, etc.). In the illustrated example of FIG. 2, the calculation set 203 includes different beverages (e.g., the channel) corresponding to flavors of orange 212 (a first market available item), caramel apple 214 (a second market available item), apple ginger 216 (a third market available item), grape 218 (a fourth market available item), honey 220 (a fifth market available item) and lime 222 (a sixth market available item).

The example weight calculating circuitry 116 determines and/or otherwise calculates a corresponding primary characteristic score for each primary characteristic in view of the focus item 202 in a manner consistent with example Equation 1.

$$Score = log \frac{number of products in catergory}{number of products with matching characteristic} . \qquad Equation 1$$

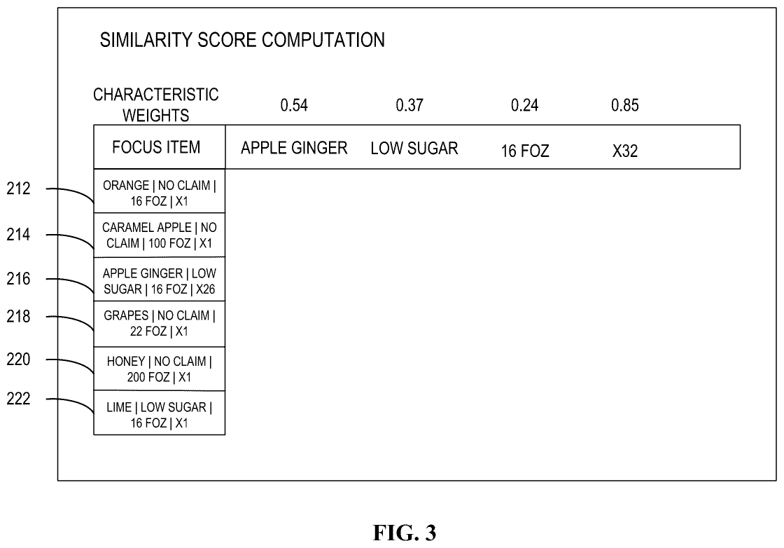

In the illustrated example of Equation 1, the weight calculating circuitry 116 calculates a weight that is also indicative of a relative rarity for the primary characteristic of interest. For example, if the focus item characteristic is the only product in the group of seven having that particular characteristic, then example Equation 1 results in a primary characteristic score of 0.845 (i.e., log(7/1)). However, if the focus item characteristic is also found in a greater number of the group of seven products (e.g., assume 3 products share the same characteristic), then example Equation 1 results in a relatively lower primary characteristic score of 0.37 (i.e., log(7/3)). Stated differently, primary characteristic scores having a higher value are indicative of a greater degree of uniqueness, as shown in FIG. 3.

In the illustrated example of FIG. 3, the weight calculating circuitry 116 calculated a primary characteristic score of 0.54 for the primary characteristic Apple Ginger (i.e., log (7/2)→seven total items and two of those that have the term “Apple Ginger”). The example weight calculating circuitry 116 calculated a primary characteristic score of 0.37 for the primary characteristic Low Sugar (i.e., log (7/3)→seven total items and three of those that have the claim “Low Sugar”). The example weight calculating circuitry 116 calculated a primary characteristic score of 0.24 for the primary characteristic 16 fluid ounces (i.e., log (7/4)→seven total items and four of those that are also 16 fluid ounces). The example weight calculating circuitry 116 calculated a primary characteristic score of 0.85 for the primary characteristic ×32 (i.e., log (7/1)→seven total items and only one of those are a pack size of 32).

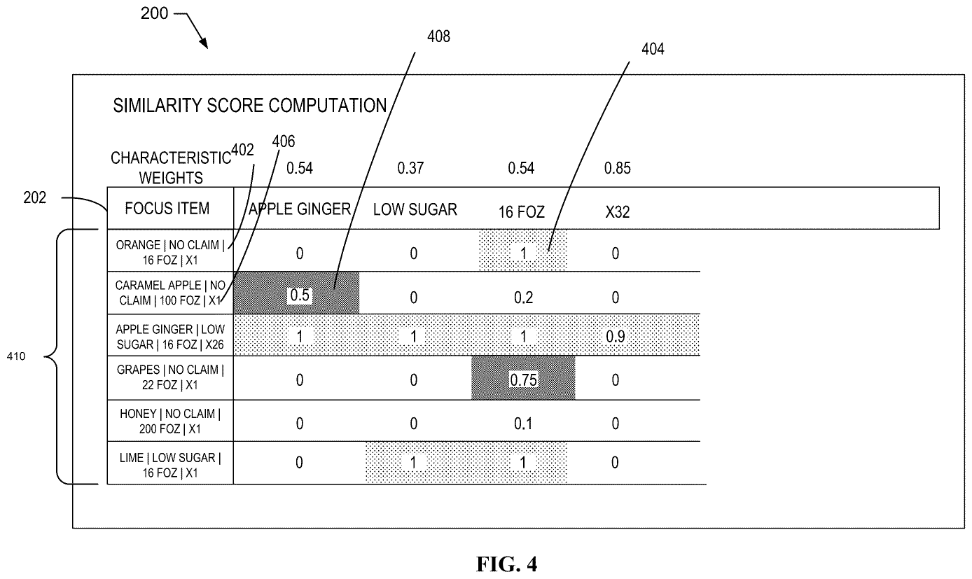

While the primary characteristic scores are indicative of a relative degree of uniqueness of the focus item in view of the market available items, the example weight calculating circuitry 116 also calculates characteristic weights for each item and its characteristics to ascertain a relative distance between the focus item 202 and each market available item. Stated differently, varying degrees of characteristics present in the focus item 202 and the market available items reveal a greater or lesser similarity based on a distance metric therebetween. Turning to the illustrated example of FIG. 4, the example distance calculating circuitry 118 selects an item from the set of market available items 410, and selects a primary characteristic for that item. Additionally, the distance calculating circuitry 118 determines whether there is a match (e.g., a binary match=1, a binary mismatch=0), or a partial match (e.g., a proportional match value between 0 and 1). For example, the focus item 202 and an example first market available product 402 both have the same volume (i.e., 16 fOZ). Accordingly, because this is an exact match the example distance calculator assigns the corresponding characteristic intersection a multiplication value of 1 (see element 404). In another example, a second market available product 406 includes a flavor characteristic of “Caramel Apple” while the focus item flavor is “Apple Ginger.” This is not an exact match, but at least half of the flavor terms include an exact match (i.e., both have the term “Apple”). As such, the example distance calculator 118 assigns a multiplication value of 0.5 (see element 408). Raw scores are calculated as a function of respective multiplication values and corresponding scores/weights.

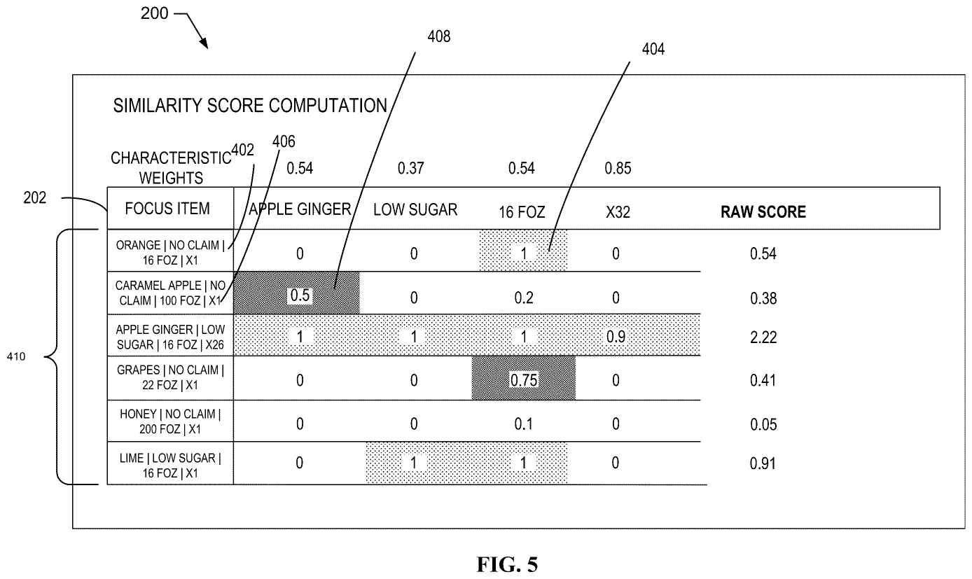

The example weight calculating circuitry 116 calculates raw scores for each market available item. In the illustrated example of FIG. 5, the example first market available item 212 (e.g., orange) includes weights of zero except for the primary characteristic 16 fluid ounces (which has a weight of 1). As such, the example weight calculating circuitry 116 calculates the raw score for the first market available item 212 as the sum for each characteristic (i.e., 0(0.54)+0(0.37)+1(0.54)+0(0.85)=0.54). Similarly, the example weight calculating circuitry 116 calculates the raw score for the second market available item 212 as the sum for each characteristic (i.e., 0.5(0.54)+0(0.37)+0.2(0.54)+0(0.85)=0.38). The example weight calculating circuitry 116 calculates raw scores for the remaining market available items in a similar manner.

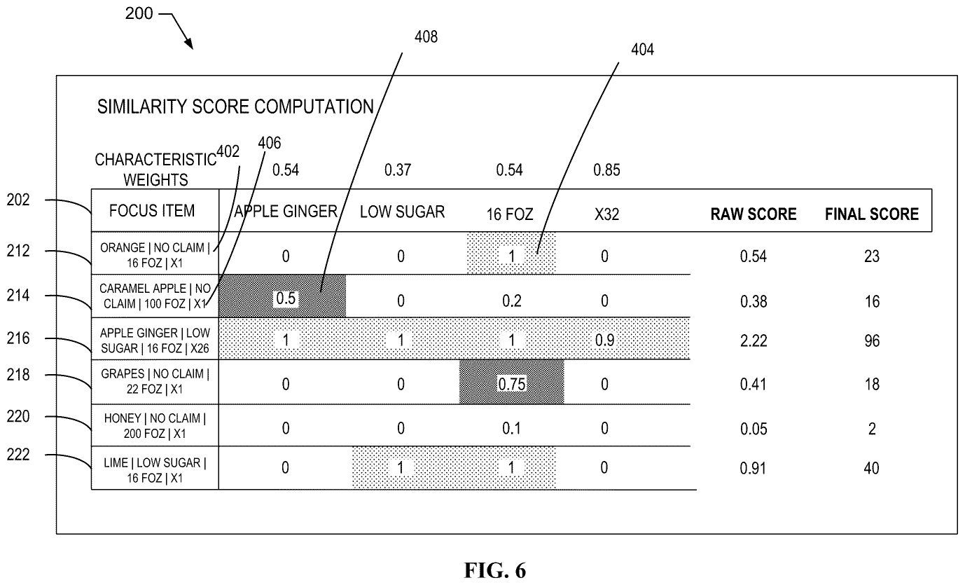

After all the raw scores are calculated for each of the market available items, the example weight calculating circuitry 116 calculates final scores for each market available item in a manner that is based on an ideal score (sometimes referred to as a best score) for the focus item. For instance, any market available item/product would require weight for all of its characteristics to have a weight value of 1 so that the product of the weight and each respective primary characteristic score can reach its maximum value. In view of such a hypothetical market available product, the ideal score would be 1(0.54)+1(0.37)+1(0.54)+1(0.85)=2.30. In the illustrated example of FIG. 6, each final score is listed in a final score column 602. As described above, the final score is based on the ideal score for the focus item 202 in a manner consistent with example Equation 2.

$$Final score = \frac{Raw Score}{Ideal Score} \times 100. \qquad Equation 2$$

In the illustrated example of FIG. 6, the market available item having the highest relative final score is the example third market available item 216 corresponding to an Apple Ginger beverage, having a final score of 96.

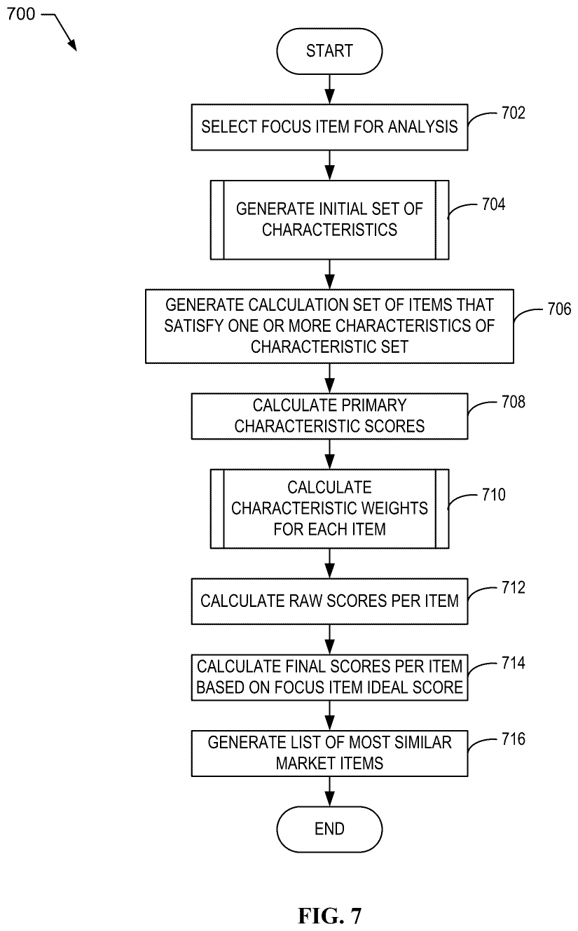

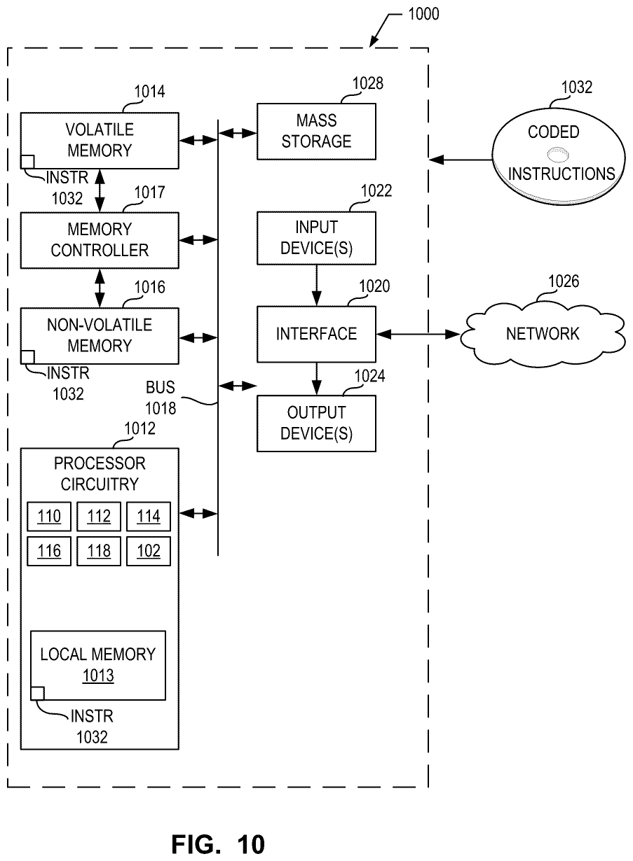

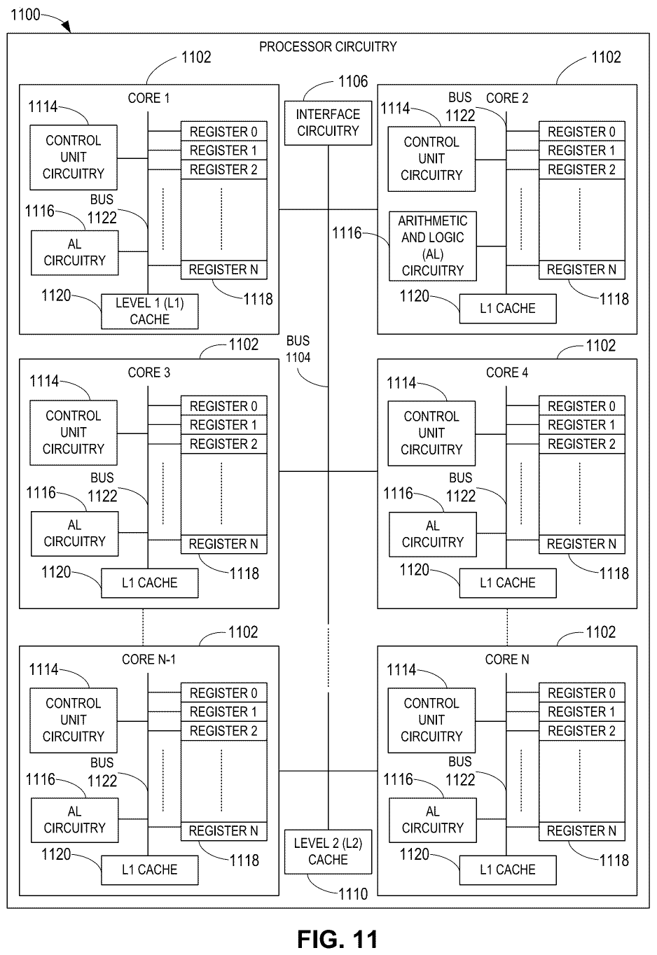

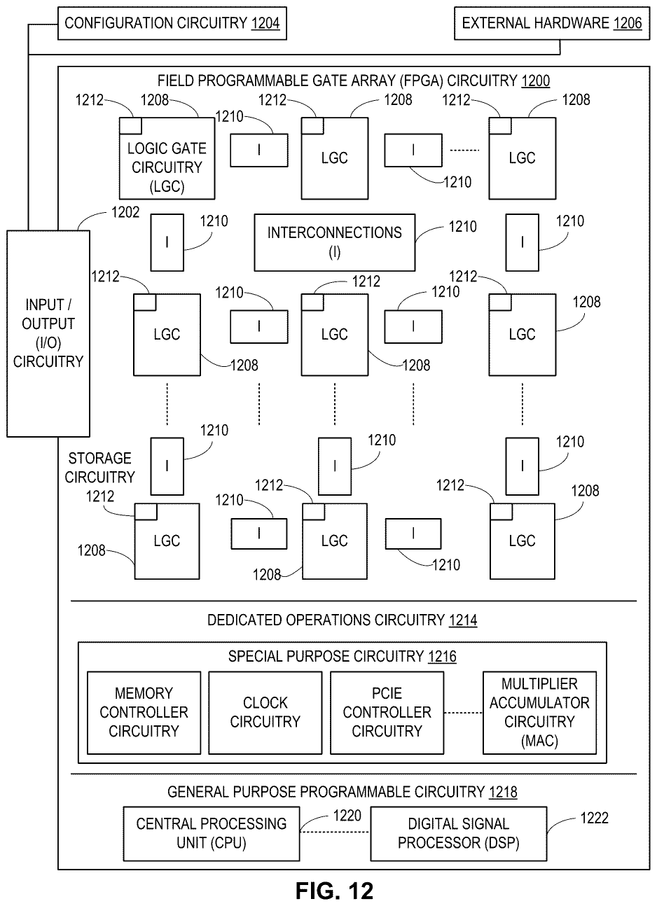

In some examples, the data set generating circuitry 110 includes means for generating a data set, the calculation set generating circuitry 112 includes means for generating a calculation set, the device controlling circuitry 114 includes means for controlling devices, the weight calculating circuitry 116 includes means for calculating weights, the distance calculating circuitry 118 includes means for calculating distance, and the similarity score calculating circuitry 102 includes means for calculating similarity scores. For example, the means for generating a calculation set may be implemented by calculation set generating circuitry 112, the means for controlling devices may be implemented by device controlling circuitry 114, the means for calculating weights may be implemented by weight calculating circuitry 116, the means for calculating distance may be implemented by distance calculating circuitry 118, and the means for calculating similarity scores may be implemented by similarity score calculating circuitry. In some examples, the aforementioned circuitry may be implemented by machine executable instructions such as that implemented by at least the blocks of FIGS. 7-9 executed by processor circuitry, which may be implemented by the example processor circuitry 1012 of FIG. 10, the example processor circuitry 1100 of FIG. 11, and/or the example Field Programmable Gate Array (FPGA) circuitry 1200 of FIG. 12. In other examples, the aforementioned circuitry is implemented by other hardware logic circuitry, hardware implemented state machines, and/or any other combination of hardware, software, and/or firmware. For example, the aforementioned circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the similarity score system 100 of FIG. 1 is illustrated in FIGS. 1-6, one or more of the elements, processes, and/or devices illustrated in FIGS. 1-6 may be combined, divided, re-arranged, omitted, eliminated, and/or implemented in any other way. Further, the example data set generating circuitry 110, the example calculation set generating circuitry 112, the example device controlling circuitry 114, the example weight calculating circuitry 116, the example distance calculating circuitry 118 and/or, more generally, the example similarity score calculating circuitry 102 of FIG. 1, may be implemented by hardware, software, firmware, and/or any combination of hardware, software, and/or firmware. Thus, for example, any of the example data set generating circuitry 110, the example calculation set generating circuitry 112, the example device controlling circuitry 114, the example weight calculating circuitry 116, the example distance calculating circuitry 118 and/or, more generally, the example similarity score calculating circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example data set generating circuitry 110, the example calculation set generating circuitry 112, the example device controlling circuitry 114, the example weight calculating circuitry 116, the example distance calculating circuitry 118 and/or, more generally, the example similarity score calculating circuitry 102 of FIG. 1 is/are hereby expressly defined to include a non-transitory computer readable storage device or storage disk such as a memory, a digital versatile disk (DVD), a compact disk (CD), a Blu-ray disk, etc., including the software and/or firmware. Further still, the example similarity score system 100 of FIG. 1 may include one or more elements, processes, and/or devices in addition to, or instead of, those illustrated in FIGS. 1-6, and/or may include more than one of any or all of the illustrated elements, processes and devices.

Flowcharts representative of example hardware logic circuitry, machine readable instructions, hardware implemented state machines, and/or any combination thereof for implementing the similarity score system 100 of FIG. 1 is shown in FIGS. 7-9. The machine readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIG. 7-9, many other methods of implementing the example similarity score system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to identify similarity scores corresponding to a focus item and any number of market available items. The machine readable instructions and/or operations 700 of FIG. 7 begin at block 702, at which the example data set generating circuitry 110 selects a focus item for analysis. The example calculation set generating circuitry 112 generates an initial set of characteristics that is derived from the particular characteristics of the focus item (block 704), as discussed above and in further detail below. The example calculation set generating circuitry 112 generates a calculation set of items that satisfy one or more primary characteristics of the characteristic set (block 706). As described above, one or more secondary characteristics are considered to cull and/or otherwise reduce the quantity of candidate items such that similarity comparisons are relevant and/or otherwise focused on items having a threshold amount of market velocity and/or influence. The example weight calculating circuitry 116 calculates primary characteristic scores in a manner consistent with example Equation 1 (block 708), and calculates characteristic weights for each item (block 710) as described above and in more detail below.

The example weight calculating circuitry 116 calculates raw scores on an item per item basis (block 712), and calculates final scores for each item based on an ideal score of the focus item (block 714). The example similarity calculating circuitry 102 then generates a list of the most similar market available items to the focus item (block 716).

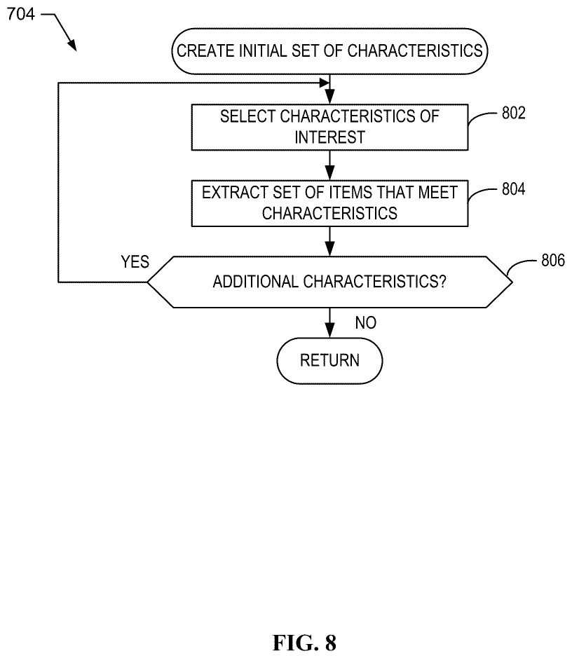

FIG. 8 illustrates additional detail corresponding to creating an initial set of characteristics of block 704. In the illustrated example of FIG. 8, the example calculation generating circuitry 112 selects characteristics of interest (block 802) and extracts a set of items that meet and/or otherwise match the selected characteristic (block 804). In the event one or more additional characteristics of interest are to be considered during the similarity analysis (block 806), then control returns to block 802 where the example calculation generating circuitry 112 selects another characteristic of interest to search for in the database of items (e.g., one or more of the example product characteristics data source 106 or the example available market product data source 108).

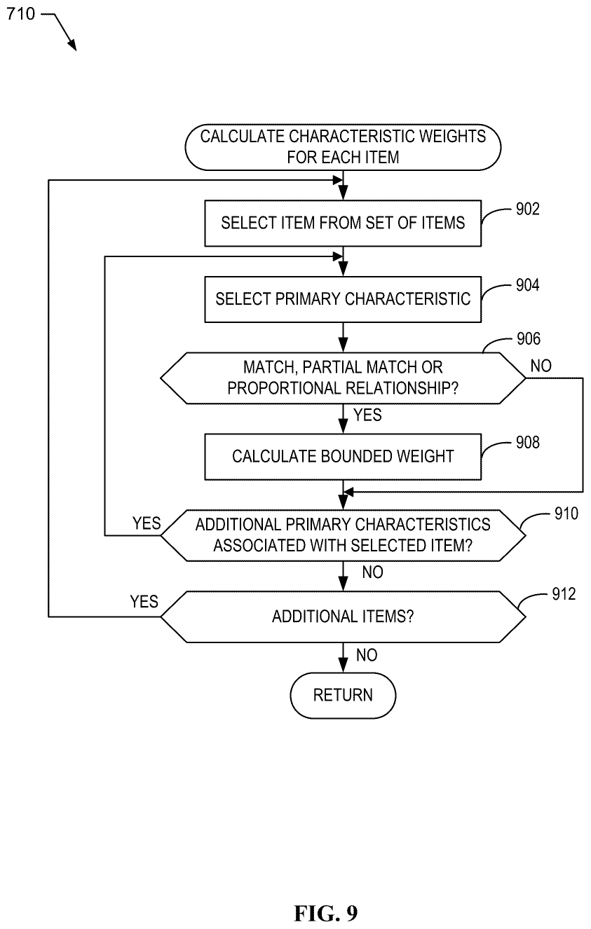

FIG. 9 illustrates additional detail corresponding to calculating characteristic weights for each item of interest (block 710). In the illustrated example of FIG. 9, the example distance calculating circuitry 116 selects an item from the set of items (block 902) and selects a primary characteristic of interest (block 904). The example distance calculating circuitry 116 determines whether the characteristic corresponds to a match, a partial match and/or a proportional match (block 906). If so, then the distance calculating circuitry 116 calculates a bounded weight between zero and one (block 908), and determines whether there are additional primary characteristics associated with the selected item (block 910). If so, control returns to block 904, otherwise the example distance calculating circuitry 116 determines whether one or more additional items remain to be analyzed for weight calculations (block 912). If so, control returns to block 902, otherwise the example returns.

FIG. 10 is a block diagram of an example processor platform 1000 structured to execute and/or instantiate the machine readable instructions and/or operations of FIGS. 7-9 to implement the similarity score system 100 of FIG. 1. The processor platform 1000 can be, for example, a server, a personal computer, a workstation, a self-learning machine (e.g., a neural network), a mobile device (e.g., a cell phone, a smart phone, a tablet such as an iPad™), a gaming console, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example data set generating circuitry 110, the example calculation set generating circuitry 112, the example device controlling circuitry 114, the example weight calculating circuitry 116, the example distance calculating circuitry 118 and/or, more generally, the example similarity score calculating circuitry 102 of FIG. 1.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine readable instructions of FIGS. 7-9, may be stored in the mass storage device 1028, in the volatile memory 1014, in the non-volatile memory 1016, and/or on a removable non-transitory computer readable storage medium such as a CD or DVD.

FIG. 11 is a block diagram of an example implementation of the processor circuitry 1012 of FIG. 10. In this example, the processor circuitry 1012 of FIG. 10 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The bus 1120 may implement at least one of an I2C bus, a SPI bus, a PCI bus, or a PCIe bus

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 12 is a block diagram of another example implementation of the processor circuitry 1012 of FIG. 10. In this example, the processor circuitry 1012 is implemented by FPGA circuitry 1200. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 7-9 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowcharts of FIG. 12. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 7-9. As such, the FPGA circuitry 1200 may be structured to effectively instantiate some or all of the machine readable instructions of the flowcharts of FIGS. 7-9 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIGS. 7-9 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine readable instructions of FIGS. 7-9 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine readable instructions represented by the flowcharts of FIGS. 7-9 may be executed by one or more of the cores 1102 of FIG. 11 and a second portion of the machine readable instructions represented by the flowcharts of FIGS. 7-9 may be executed by the FPGA circuitry 1200 of FIG. 12.

In some examples, the processor circuitry 1012 of FIG. 10 may be in one or more packages. For example, the processor circuitry 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

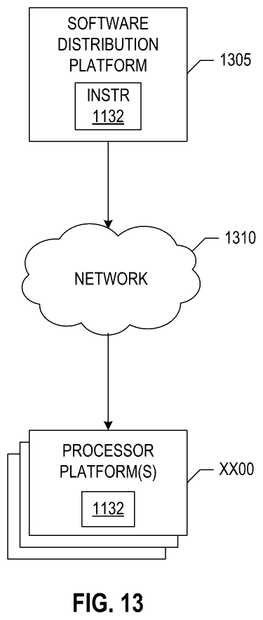

A block diagram illustrating an example software distribution platform 1305 to distribute software such as the example machine readable instructions 1032 of FIG. 10 to hardware devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 7-9, as described above. The one or more servers of the example software distribution platform 1305 are in communication with a network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIGS. 7-9, may be downloaded to the example processor platform 1000, which is to execute the machine readable instructions 1032 to implement the example system 100. In some example, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices.

From the foregoing, it will be appreciated that example systems, methods, apparatus, and articles of manufacture have been disclosed that reduce human discretionary behaviors when identifying items having a degree of similarity to an item of interest. The disclosed systems, methods, apparatus, and articles of manufacture improve the efficiency of using a computing device by reducing wasteful processing on comparisons of products that have a relatively lower likelihood of being similar to an item of interest. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to determine product similarity scores are disclosed herein. Further examples and combinations thereof include the following:

Example 1 includes an apparatus to identify item similarity metrics, comprising calculation set generating circuitry to identify a set of candidate comparison items based on primary characteristics corresponding to a focus item, and generate a calculation set of items from the set of candidate comparison items based on secondary characteristics corresponding to market performance, and weight calculating circuitry to calculate primary characteristic scores corresponding to the focus item, the primary characteristic scores based on a uniqueness between the primary characteristics corresponding to the focus item and primary characteristics corresponding to the calculation set of items.

Example 2 includes the apparatus as defined in example 1, wherein the weight calculating circuitry is to calculate the primary characteristic scores based on a ratio of (a) total items within the calculation set of items and (b) a number of items that share one of the primary characteristics corresponding to the focus item.

Example 3 includes the apparatus as defined in example 2, wherein the weight calculating circuitry is to calculate a log of the ratio to calculate the primary characteristic scores.

Example 4 includes the apparatus as defined in example 1, wherein the primary characteristics corresponding to the focus item include at least one of a flavor, a size, a example, or a pack size.

Example 5 includes the apparatus as defined in example 1, wherein the secondary characteristics include at least one of sales volume, sales volume per unit of time, or all commodities volume (ACV) metrics.

Example 6 includes the apparatus as defined in example 1, further including data set generating circuitry to identify the focus item from a list of ranked focus items to be evaluated.

Example 7 includes the apparatus as defined in example 1, further including similarity calculating circuitry to generate a list of most similar market available items based on the primary characteristic scores.

Example 8 includes a non-transitory computer readable medium comprising instructions that, when executed, cause processor circuitry to at least identify a set of candidate comparison items based on primary characteristics corresponding to a focus item, generate a calculation set of items from the set of candidate comparison items based on secondary characteristics corresponding to market performance, and calculate primary characteristic scores corresponding to the focus item, the primary characteristic scores based on a uniqueness between the primary characteristics corresponding to the focus item and primary characteristics corresponding to the calculation set of items.

Example 9 includes the non-transitory computer readable medium as defined in example 8, wherein the instructions, when executed, cause the processor circuitry to calculate the primary characteristic scores based on a ratio of (a) total items within the calculation set of items and (b) a number of items that share one of the primary characteristics corresponding to the focus item.

Example 10 includes the non-transitory computer readable medium as defined in example 9, wherein the instructions, when executed, cause the processor circuitry to calculate a log of the ratio to calculate the primary characteristic scores.

Example 11 includes the non-transitory computer readable medium as defined in example 8, wherein the instructions, when executed, cause the processor circuitry to identify primary characteristics as at least one of a flavor, a size, a example, or a pack size.

Example 12 includes the non-transitory computer readable medium as defined in example 8, wherein the instructions, when executed, cause the processor circuitry to identify the secondary characteristics as at least one of sales volume, sales volume per unit of time, or all commodities volume (ACV) metrics.

Example 13 includes the non-transitory computer readable medium as defined in example 8, wherein the instructions, when executed, cause the processor circuitry to identify the focus item from a list of ranked focus items to be evaluated.

Example 14 includes the non-transitory computer readable medium as defined in example 8, wherein the instructions, when executed, cause the processor circuitry to generate a list of most similar market available items based on the primary characteristic scores.

Example 15 includes an apparatus for identifying item similarity metrics comprising means for generating a calculation set to identify a set of candidate comparison items based on primary characteristics corresponding to a focus item, and generate a calculation set of items from the set of candidate comparison items based on secondary characteristics corresponding to market performance, and means for calculating weights to calculate primary characteristic scores corresponding to the focus item, the primary characteristic scores based on a uniqueness between the primary characteristics corresponding to the focus item and primary characteristics corresponding to the calculation set of items.

Example 16 includes the apparatus as defined in example 15, wherein the means for calculating weights is to calculate the primary characteristic scores based on a ratio of (a) total items within the calculation set of items and (b) a number of items that share one of the primary characteristics corresponding to the focus item.

Example 17 includes the apparatus as defined in example 16, wherein the means for calculating weights is to calculate a log of the ratio to calculate the primary characteristic scores.

Example 18 includes the apparatus as defined in example 15, wherein the primary characteristics corresponding to the focus item include at least one of a flavor, a size, a example, or a pack size.

Example 19 includes the apparatus as defined in example 15, wherein the secondary characteristics include at least one of sales volume, sales volume per unit of time, or all commodities volume (ACV) metrics.

Example 20 includes the apparatus as defined in example 15, further including means for generating a data set to identify the focus item from a list of ranked focus items to be evaluated.

The following claims are hereby incorporated into this Detailed Description by this reference, with each claim standing on its own as a separate embodiment of the present disclosure.

1.-20. (canceled)

21. An apparatus comprising:
interface circuitry to access a first set of comparison items from a network data source based on primary characteristics corresponding to a focus item, the first set of comparison items stored in a first data structure;
machine-readable instructions; and
at least one programmable circuit to execute the machine-readable instructions to:
generate a second data structure of a second set of comparison items smaller than the first data structure by excluding respective ones of the first set of comparison items that do not satisfy a threshold value of at least one secondary characteristic;
execute a model to:
recognize an amount of matching between a first primary characteristic of the focus item and a corresponding first primary characteristic of a first comparison item of the second set of comparison items;
based on an exact match, assign a first similarity weight value to the first primary characteristic of the first comparison item; and
based on an inexact match,
generate a proportional match value based on a proportion of text representing the first primary characteristic of the focus item that matches text representing the corresponding first primary characteristic of the first comparison item; and
assign a second similarity weight value to the first primary characteristic of the first comparison item, the second similarity weight value corresponding to the proportional match value;
generate a first characteristic score for the corresponding first primary characteristic of the first comparison item based on the first similarity weight value or the second similarity weight value; and
generate a similarity score for the first comparison item based on the first characteristic score and characteristic scores for other primary characteristics of the first comparison item corresponding to the primary characteristics of the focus item; and
output an alert for the focus item in a geographic location associated with one of the second set of comparison items corresponding to a highest one of similarity scores of the second set of comparison items, the similarity scores including the similarity score for the first comparison item.

22. The apparatus of claim 21, wherein one or more of the at least one processor circuit is to generate the first characteristic score by:
generating a uniqueness score value for the first primary characteristic of the focus item into based on a ratio of (a) a total quantity of the second set of comparison items and (b) a quantity of the second set of comparison items having the first primary characteristic of the focus item; and
applying the one of the first similarity weight value or the second similarity weight value to the uniqueness score value for the first primary characteristic of the focus item to generate the first characteristic score.

23. The apparatus of claim 22, wherein one or more of the at least one processor circuit is to determine a log of the ratio to determine the uniqueness score value.

24. The apparatus of claim 21, wherein one or more of the at least one processor circuit is to identify the primary characteristics of the focus item as at least one of a flavor, a size, a claim, or a pack size.

25. The apparatus of claim 21, wherein one or more of the at least one processor circuit is to identify the at least one secondary characteristic as at least one of sales volume, sales volume per unit of time, or all commodities volume (ACV) metrics.

26. The apparatus of claim 21, wherein one or more of the at least one processor circuit is to calculate the first similarity weight value or the second similarity weight value as a bounded weight value having a value between zero and one.

27. The apparatus of claim 21, wherein one or more of the at least one processor circuit is to rank the similarity scores of the comparison items and select the highest one of the similarity scores based on the ranking.

28. The apparatus of claim 21, wherein one or more of the at least one processor circuit is to select the focus item based on a ranking of a set of focus items corresponding to products to be interested.

29. At least one non-transitory machine-readable medium comprising machine-readable instructions to cause at least one processor circuit to at least:
generate a second data structure of a second set of comparison items smaller than a first data structure storing a first set of comparison items by excluding respective ones of the first set of comparison items that do not satisfy a threshold value of at least one secondary characteristic, the first set of comparison items having primary characteristics corresponding to a focus item, the focus item corresponding to a product to be introduced;
execute a model to:
recognize an amount of matching between a first primary characteristic of the focus item and a corresponding first primary characteristic of a first comparison item of the second set of comparison items;
based on an exact match, assign a first similarity weight value to the first primary characteristic of the first comparison item; and
based on an inexact match,
generate a proportional match value based on a proportion of text representing the first primary characteristic of the focus item that matches text representing the corresponding first primary characteristic of the first comparison item; and
assign a second similarity weight value to the first primary characteristic of the first comparison item, the second similarity weight value corresponding to the proportional match value;
generate a first characteristic score for the corresponding first primary characteristic of the first comparison item based on the first similarity weight value or the second similarity weight value; and
generate a similarity score for the first comparison item based on the first characteristic score and characteristic scores for other primary characteristics of the first comparison item corresponding to the primary characteristics of the focus item; and
output an alert for the focus item in a geographic location associated with one of the second set of comparison items corresponding to a highest one of similarity scores of the second set of comparison items, the similarity scores including the similarity score for the first comparison item.

30. The at least one non-transitory machine-readable medium of claim 29, wherein the machine-readable instructions are to cause one or more of the at least one processor circuit to generate the first characteristic score by:
generating a uniqueness score value for the first primary characteristic of the focus item into based on a ratio of (a) a total quantity of the second set of comparison items and (b) a quantity of the second set of comparison items having the first primary characteristic of the focus item; and
applying the one of the first similarity weight value or the second similarity weight value to the uniqueness score value for the first primary characteristic of the focus item to generate the first characteristic score.

31. The at least one non-transitory machine-readable medium of claim 30, wherein the machine-readable instructions are to cause one or more of the at least one processor circuit to determine a log of the ratio to determine the uniqueness score value.

32. The at least one non-transitory machine-readable medium of claim 29, wherein the machine-readable instructions are to cause one or more of the at least one processor circuit to identify the primary characteristics of the focus item as at least one of a flavor, a size, a claim, or a pack size.

33. The at least one non-transitory machine-readable medium of claim 29, wherein the machine-readable instructions are to cause one or more of the at least one processor circuit to identify the at least one secondary characteristic as at least one of sales volume, sales volume per unit of time, or all commodities volume (ACV) metrics.

34. The at least one non-transitory machine-readable medium of claim 29, wherein the machine-readable instructions are to cause one or more of the at least one processor circuit to calculate the first similarity weight value or the second similarity weight value as a bounded weight value having a value between zero and one.

35. The at least one non-transitory machine-readable medium of claim 29, wherein the machine-readable instructions are to cause one or more of the at least one processor circuit to rank the similarity scores of the comparison items and select the highest one of the similarity scores based on the ranking.
